(19) United States
(12) Patent Application Publication
(10) Pub. No.: US 2025/0046501 A1
(43) Pub. Date: Feb. 6, 2025

(54) ELECTRONIC PERMANENT MAGNET AND CONTROL METHOD THEREOF

(71) Applicants: Jaejun PARK, Hanam-si (KR); KOREA ADVANCED INSTITUTE OF SCIENCE AND TECHNOLOGY, Daejeon (KR)

(72) Inventors: Hae-Won PARK, Daejeon (KR); Yong UM, Daejeon (KR); Jaejun PARK, Hanam-si (KR)

(21) Appl. No.: 18/761,547

(22) Filed: Jul. 2, 2024

(30) Foreign Application Priority Data
Jul. 4, 2023 (KR) 10-2023-0086509

(51) Int. Cl. H01F 7/20; H01F 7/02; H01F 7/04

(52) U.S. Cl. CPC H01F 7/206; H01F 7/021; H01F 7/0273; H01F 7/04; H01F 2007/208

(57) ABSTRACT

Disclosed is an electro-permanent magnet (EPM) including a structure. The structure includes at least one first magnet, at least one second magnet, at least one core associated with formation of a magnetic field within the structure, and a device configured to change a direction of a magnetic field of the at least one first magnet, wherein the core is arranged between the first magnet and the second magnet, and the first magnet and the second magnet are connected via the core.

### CROSS-REFERENCE TO RELATED APPLICATION

This application claims priority to and the benefit of Korean Patent Application No. 10-2023-0086509 filed in the Korean Intellectual Property Office on Jul. 4, 2023, the entire contents of which are incorporated herein by reference.

### BACKGROUND

### (a) Field of the Invention

The present disclosure relates to an electro-permanent magnet.

### (b) Description of the Related Art

A robot is an automated machine device that can imitate behaviors similar to those of humans or animals, or perform specific tasks. Robots apply knowledge from various fields such as electronics, computer science, mechanical engineering, and artificial intelligence, and can be used in various fields such as space exploration, military, medical, industrial, educational, and home appliances. The history of robots dates back to ancient Greece, and in the 20th century, electronic robots were developed. Currently, various types of robots are being researched, such as android robots with human-like appearances and expressions and bio-robots that imitate animals.

Robots can be used in environments that are difficult or dangerous for humans to work in directly, especially in many industrial tasks (e.g., inspecting storage tanks, bridges, and shipyards). These industrial tasks are performed in ferromagnetic environments that include gaps, protrusions, edges, walls and ceilings, and robots used in these environments are required to perform a potentially wide variety of maneuvers in complex 3D (three-dimensional) environments. To swiftly and robustly navigate a variety of maneuver scenarios, a legged robot requires an appropriate suction (adhesion) mechanism.

The most generally adopted adhesion (attraction) mechanism uses pneumatic adhesion (suction), which uses a vacuum pump and a passive suction cup that are effective on smooth surfaces regardless of materials. However, there is a problem that a movement speed of a robot is limited due to the time delay caused by applying the high energy cost and pressure required for the vacuum pump.

On the other hand, for robots working in ferromagnetic environments, an electro-permanent magnet can be used to implement an electrical adhesion (attraction) mechanism. The electrical adhesion (attraction) mechanism can effectively provide an attractive (adhesive) force on various terrains ranging from smooth surfaces to curved surfaces by using electrical adhesion pads, and has advantages of being energy-efficient and independent of the shape of the surface. An electro-permanent magnet can be used for such an electrical adhesion (attraction) mechanism.

However, electro-permanent magnets of the related art have a rather long switching time between an on state in which an attractive force is present and an off state in which no attractive force is present. In addition, since the attractive force of an electro-permanent magnet is proportional to its area, a large permanent magnet is required for high attractive force, which has the disadvantage of increasing the weight relative to the attractive force.

### SUMMARY

The present disclosure relates to an electro-permanent magnet and a method for controlling the same.

According to some exemplary embodiments, there is provided an electro-permanent magnet (EPM) including a structure, wherein the structure includes at least one first magnet, at least one second magnet, at least one core associated with formation of a magnetic field within the structure, and a device configured to change a direction of a magnetic field of the at least one first magnet. The core may be arranged between the first magnet and the second magnet, and the first magnet and the second magnet may be connected via the core.

The structure may include at least one first structure in which the core and the first magnet are connected, and at least one second structure in which the core and the second magnet are connected, and the at least one first structure and the at least one second structure may be connected alternately with each other.

The structure may be formed that the core of the first structure and the second magnet of the second structure are connected, and the core of the second structure and the first magnet of the first structure are connected.

The first magnet and the above second magnet may not be in contact with each other.

The structure may correspond to a rectangle, and a first direction formed by a central magnetic field of the first structure and a second direction formed by a central magnetic field of the second structure may form an angle.

The first magnet and the second magnet may include materials different from each other.

The first magnet may include a soft or semi-hard magnetic material, and the second magnet may include a hard magnetic material.

The first magnet may include a ferromagnetic material, and the second magnet may include a hard magnetic material.

The device may be configured to switch an activated state in which a first external magnetic field is generated and a deactivated state in which a second external magnetic field smaller than the first external magnetic field is generated or an external magnetic field is not generated.

The device may include a wire winding or a solenoid and may be at least partially arranged on the first magnet.

The electro-permanent magnet may include a magnetorheological elastomer (MRE), and the magnetorheological elastomer may include magnetic particles and an elastomer.

According to some embodiments, there is provided an electronic device including an electro-permanent magnet (EPM) including a structure; and a controller configured to control the electro-permanent magnet. The structure may include at least one first magnet, at least one second magnet, at least one core associated with formation of a magnetic field within the structure, and a device configured to change a direction of a magnetic field of the at least one first magnet. The controller may be configured to control the device to switch an activated state in which a first external magnetic field is generated and a deactivated state in which a second external magnetic field smaller than the first external magnetic field is generated or an external magnetic field is not generated.

The controller may be configured to control the device to change a direction of a magnetic field of each of the at least one first magnet.

The electro-permanent magnet may include the first magnet and the second magnet provided in plural in equal quantities, and the controller may be configured to control the device to change magnetization of at least one first magnet among the plurality of first magnets so as to change an intensity of the first external magnetic field.

According to some embodiments, there is provided a method of operating an electronic device including an electro-permanent magnet (EPM), the method including controlling a device configured to change a direction of a magnetic field of at least one first magnet included in the electro-permanent magnet, thereby switching an activated state in which a first external magnetic field is generated and a deactivated state in which a second external magnetic field smaller than the first external magnetic field is generated or an external magnetic field is not generated.

The switching may include switching to the activated state when there is an adhesion requirement situation to a ferromagnetic environment, and switching to the deactivated state when the adhesion requirement situation is terminated.

According to the present disclosure, it is possible to contribute to the attractive force without omission of the magnetic field, thereby reducing the weight compared to electro-permanent magnets of the related art that provide the same attractive force. According to the present disclosure, it is possible to shorten a switching time between an on state in which the attractive force is present and an off state in which no attractive force is present.

### BRIEF DESCRIPTION OF THE DRAWINGS

FIGS. 1A and 1B are conceptual diagrams for illustrating an electro-permanent magnet of the related art.

FIGS. 2A and 2B are conceptual diagrams for illustrating an electro-permanent magnet according to an exemplary embodiment.

FIGS. 3A and 3B are conceptual diagrams for illustrating a magnetic field direction of the electro-permanent magnet according to the exemplary embodiment.

FIGS. 4A and 4B are conceptual diagrams for illustrating a magnetic field direction of the electro-permanent magnet according to the exemplary embodiment.

FIG. 5 is a conceptual diagram for illustrating an MRE pad according to an exemplary embodiment.

FIGS. 6A and 6B are conceptual diagrams for illustrating an electro-permanent magnet according to an exemplary embodiment.

FIGS. 7A and 7B are conceptual diagrams for illustrating a magnetic field direction of the electro-permanent magnet according to the exemplary embodiment.

FIGS. 8A and SB are conceptual diagrams for illustrating a magnetic field direction of the electro-permanent magnet according to the exemplary embodiment.

FIGS. 9A and 9B are conceptual diagrams for illustrating an electro-permanent magnet according to an exemplary embodiment.

FIGS. 10A and 10B are conceptual diagrams for illustrating a magnetic field direction of the electro-permanent magnet according to the exemplary embodiment.

FIGS. 11A and 11B are conceptual diagrams for illustrating a magnetic field direction of the electro-permanent magnet according to the exemplary embodiment.

FIGS. 12A and 12B are conceptual diagrams for illustrating the electro-permanent magnet according to the exemplary embodiment.

FIG. 13 is a conceptual diagram for illustrating an electro-permanent magnet according to an exemplary embodiment.

FIGS. 14A and 14B are conceptual diagrams for illustrating a magnetic field direction of the electro-permanent magnet according to the exemplary embodiment.

FIGS. 15A and 15B are conceptual diagrams for illustrating a magnetic field direction of the electro-permanent magnet according to the exemplary embodiment.

### DETAILED DESCRIPTION OF THE EMBODIMENTS

Like reference numerals refer to like constituent elements throughout the specification. In the present specification, not all elements of the exemplary embodiments will be described, and the description of what is generally known in the art to which the disclosed invention pertains or what overlap each other in the exemplary embodiments will be omitted. As used herein, terms such as “unit (part)”, “module”, “member”, and “block” may be implemented as software or hardware. According to exemplary embodiments, a plurality of “units (parts)”. “modules”, “members”, and “blocks” may be implemented as a single constituent element, or a single “unit (part)”, “module”, “member”, and “block” may include a plurality of constituent elements.

Throughout the specification, when an element is referred to as being “connected” to another element, it can be directly or indirectly connected to another element, wherein the indirect connection includes “connection via a wireless communication network”.

In addition, unless explicitly described to the contrary, the word “comprise” or “include” and variations, such as “comprises” or “includes” or “comprising” or “including”, will be understood to imply the inclusion of stated constituent elements but not the exclusion of any other constituent elements.

Throughout the present specification, when a member is referred to as being “on” another member, the member can be in direct contact with another member or an intervening member may also be present.

The terms such as first and second are used to discriminate one constituent element from another constituent element, and the constituent elements are not limited by the terms.

The singular forms “a”, “an” and “the” are intended to include plural forms as well, unless the context clearly indicates otherwise.

An identification code in each step is used for convenience of description and does not describe the order of each step. Each step may be performed in the order different than the stated order unless the context clearly indicates a specific order.

Hereinafter, the operation principle and exemplary embodiments of the disclosed invention will be described with reference to the accompanying drawings.

An electro-permanent magnet (EPM) is an attraction mechanism that provides an attractive force to an object made of iron, and its use is similar to those of electromagnets and permanent magnets. However, permanent magnets cannot control an attractive force, and a special device is necessarily required to enable attachment and detachment. Electromagnets have an advantage in that when current is caused to pass through a coil, an attractive force is generated, and when no current is caused to pass, no attractive force is generated, facilitating attachment and detachment. However, the electromagnets have an energy inefficiency aspect in that the attractive force is maintained only when current is continuously supplied. On the other hand, an electro-permanent magnet is an attraction mechanism (device) that simultaneously has the advantages of both the permanent magnet and the electromagnet. Like the permanent magnets, no energy is required to maintain the on state in which an attractive force is present or the off state in which no attractive force is present, and like the electromagnets, attachment and detachment can be achieved simply by causing current to instantaneously pass through the coil. That is, unlike the electromagnets, the electro-permanent magnet has the characteristic of being energy-efficient because no continuous energy is required to maintain each state.

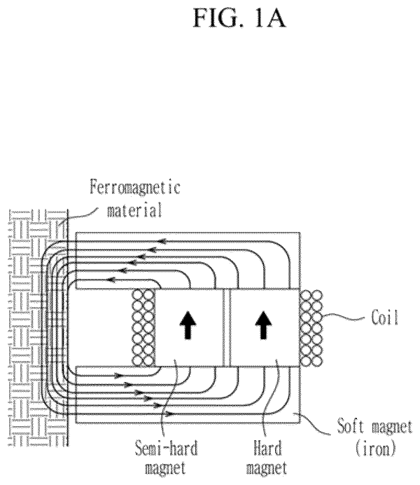

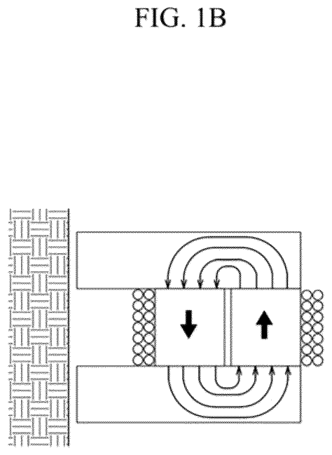

FIGS. 1A and 1B are conceptual diagrams for illustrating an electro-permanent magnet of the related art.

Referring to FIG. 1A, an electro-permanent magnet of the related art may include a magnet including a soft or semi-hard magnetic material (hereinafter, referred to as a first magnet) and a magnet including a hard magnetic material (hereinafter, referred to as a second magnet). The first magnet has a property of being able to easily change a magnetization direction, while the second magnet bas a property of not being able to change a magnetization direction. Accordingly, the magnetization direction of the first magnet is changed depending on a current direction of a coil wound around the first and second magnets, and thus a state in which an attractive force is provided and a state in which no attractive force is provided can be switched.

Since a magnetic field has a property of being formed inside a magnetic material rather than outside the magnetic material, a magnetic field can be formed through a ferromagnetic material when the magnetization directions of the first magnet and the second magnet are the same. Accordingly, the electro-permanent magnet of the related art can provide an attractive force to the ferromagnetic material.

Referring to FIG. 1B, when the magnetization directions of the first magnet and the second magnet are opposite, a magnetic field is formed inside the magnetic material and is not formed inside the ferromagnetic material, so that an attractive force cannot be provided to the ferromagnetic material.

However, the electro-permanent magnet of the related art has a problem in that the arrangement of the first magnet and the second magnet in parallel results in an unnecessary increase in the arrangement of the coil, leading to increased coil resistance, which in turn raises an operating voltage and causes a somewhat significant delay in switching time. In addition, since the attractive force of an electro-permanent magnet is proportional to its area, a large permanent magnet is required for a large attractive force, which causes a problem that the weight increases relative to the attractive force.

In addition, referring to Korean Patent No. KR10-2168033, the electro-permanent magnet of the related art has a problem in that, in an on state in which an attractive force is present, a magnetic field is formed through an upper yoke part and a lower yoke part, contributing to the attractive force at a ratio of half of the total magnetic field, resulting in a somewhat lower attractive force relative to the same weight.

The following describes in detail an electro-permanent magnet and a control method thereof that can solve the problems of electro-permanent magnets of the related art.

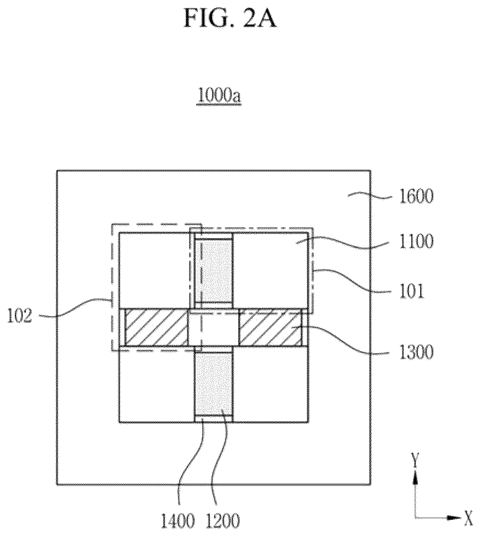

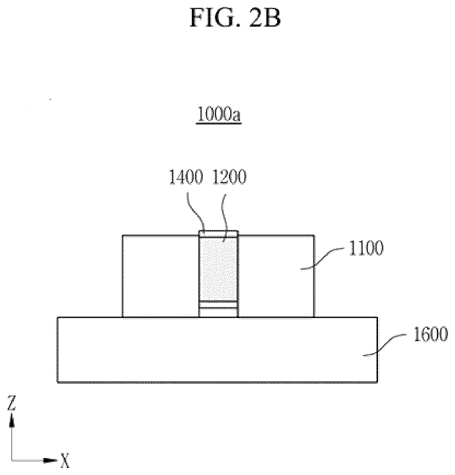

FIGS. 2A and 2B are conceptual diagrams for illustrating an electro-permanent magnet according to an exemplary embodiment.

Referring to FIGS. 2A and 2B, a first magnet 1200 and a device 1400 are shown separately; however, this separation is for convenience of description, and the first magnet 1200 may be at least partially surrounded by the device 1400. Accordingly, the first magnet 1200 may not be exposed to the outside. Also, in the drawings below, the first magnet 1200 and the device 1400 are shown separately for convenience of description; however, this separation may show a state in which the first magnet 1200 is not exposed due to a relationship between the device 1400 and the first magnet 1200. FIG. 2B is a conceptual diagram of the electro-permanent magnet 1000a of FIG. 2A viewed in a ty direction.

Referring to FIG. 2A, the electro-permanent magnet 1000a according to a first exemplary embodiment of the present disclosure may be an electro-permanent magnet (EPM) including a structure. More specifically, the electro-permanent magnet 1000a may include at least one core 1100 associated with formation of a magnetic field within the structure, at least one first magnet 1200, at least one second magnet 1300, and a device 1400 configured to change a direction of a magnetic field of the at least one first magnet.

The electro-permanent magnet 1000a may be in contact with a ferromagnetic material 1600. More specifically, the electro-permanent magnet 1000a can provide an attractive force to a ferromagnetic environment depending on a magnetization direction. That is, the ferromagnetic material 1600 may be included in a ferromagnetic environment so that the electro-permanent magnet 1000a can provide an attractive (adhesive) force. Accordingly, the ferromagnetic material 1600 described in the present disclosure is a ferromagnetic material 1600 included in a ferromagnetic environment, and can be interpreted as referring to the ferromagnetic environment.

The first magnet 1200 and the second magnet 1300 may include materials different from each other. That is, the first magnet 1200 and the second magnet 1300 may be composed of magnets and/or electromagnets having magnetic forces different from each other.

The first magnet 1200 may include a soft or semi-hard magnetic material, and the second magnet may include a hard magnetic material. For example, the first magnet 1200 may be an AlNiCo magnet whose direction of magnetic force changes, but this is only an example, and no such limitation is intended.

Since the first magnet 1200 includes a soft or semi-hard magnetic material, the magnetization direction of the first magnet 1200 can be changed according to formation of a temporary magnetic field. That is, in the first magnet 1200, a local and/or temporary magnetic field generated externally or internally can change the polarity, thereby changing the magnetization direction. The first magnet 1200 can maintain the direction of the magnetic field changed according to the formation of the temporary and/or local magnetic field, and no additional energy cost is consumed for this.

On the other hand, in another exemplary embodiment, the first magnet 1200 may be made of a ferromagnetic material, like the core 1100, which can increase the intensity of a magnetic field. That is, the first magnet 1200 may be made of iron (Fe), cobalt (Co), nickel (Ni), tungsten (W), or the like, which can induce a magnetic field and form a path (magnetic current) through which a magnetic flux flows, according to an operation of the device 1400 described in detail below. However, this is an example, and no such limitation is intended. For example, the first magnet 1200 may be made of a ferromagnetic material discovered later. That is, when the first magnet 1200 is made of a ferromagnetic material, like the core 1100, the electro-permanent magnet 1000 may require continuous current supply through the device 1400 so as to maintain the attractive force. This is an example, and no such limitation is intended. That is, as an example of the first magnet 1200 described above and/or below, a permanent magnet whose magnetization direction can be changed, including a soft or semi-hard magnetic material, will be mainly described, but it can also be implemented as an electromagnet through the core 1100 and the device 1400.

The second magnet 1300 according to an exemplary embodiment of the present disclosure may include a hard magnetic material. For example, the second magnet 1300 may be composed of a neodymium (NdFeB) magnet. That is, the second magnet 1300 may be composed of a permanent magnet whose direction of magnetic force is fixed.

The core 1100 of the electro-permanent magnet 1000a is arranged between the first magnet 1200 and the second magnet 1300, and the first magnet 1200 and the second magnet 1300 can be connected via the core 1100. That is, in the electro-permanent magnet 1000a, the first magnet 1200 and the second magnet 1300 may be alternately arranged with each other in an order of the core 1100, the first magnet 1200, the core 1100, the second magnet 1300, the core 1100, the first magnet 1200, and the like. However, this is an example, and no such limitation is intended.

The device 1400 according to an exemplary embodiment of the present disclosure may be configured to change the direction of the magnetic field of the first magnet 1200. For example, the device 1400 may be a wire winding or solenoid provided in a form of surrounding at least part of at least one first magnet 1200. That is, the device 1400 may be configured in a form of a coil that surrounds at least part of the first magnet 1200.

Accordingly, when electric pulses are supplied through the device 1400, a local magnetic field may be generated in the part of the first magnet 1200 at least partially surrounded by the device 1400. The magnetic field generated by the device 1400 can change the magnetization direction of at least one first magnet 1200. That is, the polarity of the first magnet 1200 can be changed according to the operation of the device 1400. For example, the device 1400 can change the magnetization direction of the first magnet 1200 by generating a current pulse in a (+) direction or a current pulse in a (−) direction.

Note that the device 1400 provided in the form of a coil including a wire winding or solenoid can change the direction of the magnetic field differently depending on a winding direction and a direction of current. This is a well-known technology, so the detailed description will be omitted.

Referring to FIG. 2A, the first magnet 1200 and the second magnet 1300 of the electro-permanent magnet 1000a according to the first exemplary embodiment of the present disclosure can be connected around the core 1100. More specifically, the first magnet 1200 and the second magnet 1300 can be connected around the core 1100 to form a structure of the electro-permanent magnet 1000a. The electro-permanent magnet 1000a according to the first exemplary embodiment is formed as a square-shaped structure, but this is only an example, and no such limitation is intended.

The structure of the electro-permanent magnet 1000a may include at least one first structure 101 in which the core 1100 and the first magnet 1200 are connected, and at least one second structure 102 in which the core 1100 and the second magnet 1300 are connected. Here, ‘connected’ may refer to being electrically connected and/or connected to be in physical contact.

That is, the structure of the electro-permanent magnet 1000a may include at least one first structure 101 and at least one second structure 102. As shown, the electro-permanent magnet 1000a may be formed as a square-shaped structure, including at least two first structures 101 and at least two second structures 102. More specifically, the structure of the electro-permanent magnet 1000a may be formed by at least one first structure 101 and at least one second structure 102 being alternately connected with each other. ‘Alternately connected’ may refer to a state in which the core 1100 of the first structure 101 and the second magnet 1300 of the second structure 102 are connected and the core 1100 of the second structure 102 and the first magnet 1200 of the first structure 101 are connected, resulting in an alternate connection.

Note that the first structures 101 and the second structures 102 may be alternately connected so that the first magnet 1200 of the first structure 101 and the second magnet 1300 of the second structure 102 included in the structure of the electro-permanent magnet 1000a according to the first exemplary embodiment of the present disclosure are not in contact with each other.

More specifically, the shapes of the core 1100, the first magnet 1200, and the second magnet 1300 may be changed corresponding to the shape of the structure of the electro-permanent magnet 1000a according to the first exemplary embodiment of the present disclosure. For example, as shown, when the structure of the electro-permanent magnet 1000a according to the first exemplary embodiment is configured in a square shape, the core 1100 may be provided in a hexahedron shape. In this case, the core 1100 of the second structure 102 may be connected to the first magnet 1200 of the first structure 101 at a different portion from a portion connected to the second magnet 1300 of the second structure 102. Accordingly, the second structures 102 and the first structures 101 are alternately connected, so that the first magnet 1200 and the second magnet 1300 included in the first structure 101 and the second structure 102, respectively, may not be in contact with each other.

In other words, the electro-permanent magnet 1000a according to the first exemplary embodiment of the present disclosure may include a square-shaped structure, and the core 1100 may be arranged at each vertex of the structure. Additionally, the first magnet 1200 and the second magnet 1300 may be arranged between the respective cores 1100. Accordingly, the structure of the electro-permanent magnet 1000a may have the first magnets 1200 and the second magnets 1300 alternately arranged in gaps between the respective cores 1100. However, this is an example, and the shape of the core 1100 is not limited thereto.

For example, in the first structure 101 and the second structure 102 included in the structure of the electro-permanent magnet 1000a according to the first exemplary embodiment of the present disclosure, a first direction formed by a central magnetic field of the first structure 101 and a second direction formed by a central magnetic field of the second structure 102 may be formed to have an angle of 90 degrees with respect to each other. However, this is an example, and the angles of the first and second directions may be set differently. In another exemplary embodiment, the first direction and the second direction may be set differently depending on the shape of the structure. For example, the structure of the electro-permanent magnet 1000a may correspond to a rhombus shape, and an angle formed by the first direction formed by the central magnetic field of the first structure 101 of a first group and the second direction formed by the central magnetic field of the second structure 102 of the first group and an angle formed by the first direction formed by the central magnetic field of the first structure 101 of a second group and the second direction formed by the central magnetic field of the second structure 102 of the second group may be set differently.

Note that the shapes of the first magnet 1200 and the second magnet 1300 may be varied to connect the respective cores 1100. For example, an angle between surfaces of the first magnet 1200 and the second magnet 1300 in contact with the core 1100 may be set corresponding to the shape of the structure of the electro-permanent magnet 1000a. For example, when the structure of the electro-permanent magnet 1000a has a square shape, a normal direction of a surface of the core 1100 of the first structure 101 in contact with the first magnet 1200 and a normal direction of a surface of the core 1100 of the first structure 101 in contact with the second magnet 1300 may be perpendicular. Accordingly, surfaces of the first magnet 1200 in contact with the core 1100 of the first structure 101 and the core 1100 of the second structure 102 may be parallel to each other.

Referring to FIG. 2B, the first magnet 1200 and/or the second magnet 1300 of the electro-permanent magnet 1000a may be provided between the cores 1100, but may be arranged at a distance from a lower surface of the core 1100 in the y-axis direction so as not to come into contact with the ferromagnetic material 1600. That is, the first magnet 1200 and/or the second magnet 1300 may be provided to be smaller in size than the core 1100 so as not to come into contact with the ferromagnetic environment between the cores 1100. Note that since the first magnet 1200 can be at least partially surrounded by the device 1400 in the form of a coil, the first magnet can be provided to be smaller than the core 1100, including the size of the device 1400. However, this is an example, and no such limitation is intended.

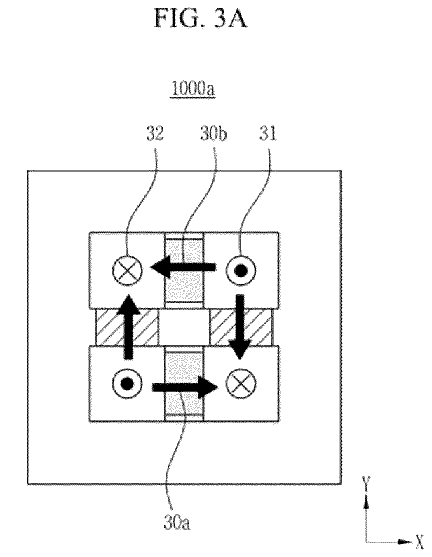

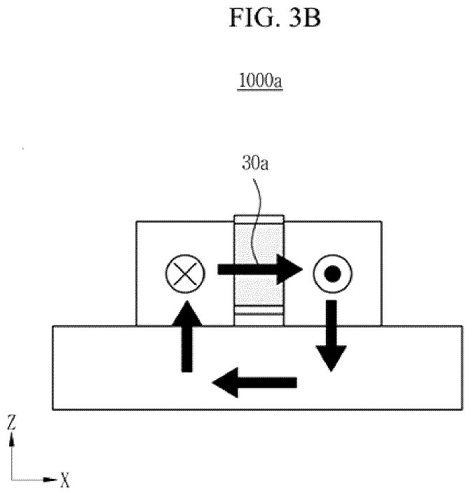

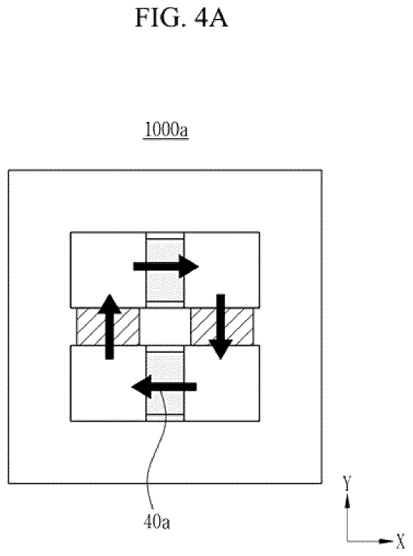

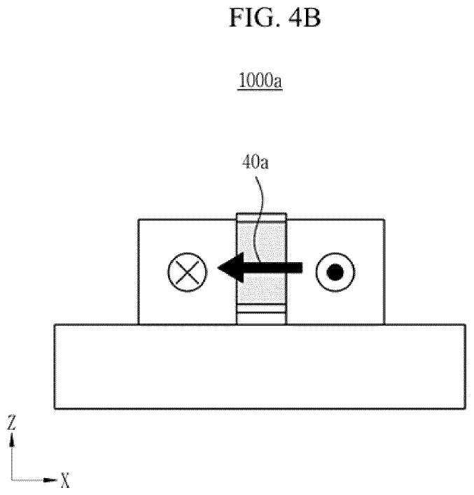

Below, with reference to FIGS. 3 and 4, a state (on state) in which the attractive force of the electro-permanent magnet 1000a according to the first exemplary embodiment of the present disclosure is present and a state (off state) in which no attractive force is present will be described.

FIGS. 3A and 3B are conceptual diagrams for illustrating a magnetic field direction of the electro-permanent magnet according to the exemplary embodiment.

Referring to FIGS. 3A and 3B, the second magnet 1300 of the electro-permanent magnet 1000a may include a magnet having higher coercivity than that of the first magnet 1200. That is, the first magnet 1200 has lower coercivity than that of the second magnet 1300, so that the magnetization direction thereof can be easily changed. In this case, the device 1400 can change magnetic field directions 30a and 30b of the first magnets 1200 through a current pulse so that the magnetic field of the first magnet 1200 is directed toward the core 1100 adjacent to the first magnet 1200, toward which the magnetic field direction of the second magnet 1300 is directed. FIG. 3B is a view of the electro-permanent magnet 1000a of FIG. 3A viewed in the +y direction.

More specifically, the device 1400 can cause the magnetic field directions of the first magnet 1200 and the second magnet 1300 to be directed toward the same core 1100 through a current pulse. Accordingly, magnetic fluxes from the first magnet 1200 and the second magnet 1300 are concentrated in the core 110, and the concentrated magnetic fluxes can form a magnetic current directed toward the ferromagnetic material 1600 in contact with the core 1100. That is, as shown, in the plan view (FIG. 3A) of the electro-permanent magnet 1000a, a magnetic field 30b formed by the first magnet 1200 and a magnetic field formed by the second magnet 1300 may be formed in a direction 32 entering the core 1100, while in the opposite core 1100, the magnetic fields may be formed in an exiting direction 31.

Referring to FIG. 3B, the electro-permanent magnet 1000a according to the first exemplary embodiment of the present disclosure can form a first external magnetic field when the device 1400 changes the magnetization direction formed by the first magnet 1200 toward the adjacent core 1100 in the magnetization direction formed by the second magnet 1300. Here, the first external magnetic field may be formed along the first magnet 1200, the cores 1100 adjacent to the first magnet 1200, and the ferromagnetic material 1600. Accordingly, the electro-permanent magnet 1000a can obtain an attractive force (adhesive force) to the ferromagnetic material 1600. This is referred to as an activated state (on state) of the electro-permanent magnet 1000a. Note that an external magnetic field including the first external magnetic field and a second external magnetic field may refer to a magnetic field generated external to the structure of the electro-permanent magnet 1000a.

FIGS. 4A and 4B are conceptual diagrams for illustrating a magnetic field direction of the electro-permanent magnet according to the exemplary embodiment.

Referring to FIGS. 4A and 4B, the device 1400 can change the direction of the magnetic field of the first magnet 1200 through a current pulse so that it is directed toward the core 1100 in the direction of the magnetic field of the second magnet 1300 and another core 1100 adjacent to the second magnet 1300. That is, the device 1400 can change the direction of the magnetic field of the first magnet 1200 so as to form a magnetic current inside the structure of the electro-permanent magnet 1000a. FIG. 4B is a view of the electro-permanent magnet 1000a of FIG. 4A viewed in the +y direction.

Accordingly, in the electro-permanent magnet 1000a according to an exemplary embodiment of the present disclosure, an external magnetic field may not be formed when the device 1400 changes the magnetic field direction of the first magnet 1200 and thus an internal magnetic current is formed in the core 1100, the first magnet 1200, and the second magnet 1300. That is, the electro-permanent magnet 1000a can maintain a deactivated state (off state) in which it generates a second external magnetic field smaller than the first external magnetic field described in FIG. 3, or generates no external magnetic field.

That is, when the electro-permanent magnet 1000a according to an exemplary embodiment of the present disclosure is in the deactivated state (off state), the magnetic field 40a generated by the first magnet 1200 and the second magnet 1300 forms a magnetic current inside the structure of the electro-permanent magnet 1000a and may have no attractive force or have an attractive force weaker than that in the activated state (on state) due to no external magnetic field being generated or the second external magnetic field being smaller than the first external magnetic field.

Note that in FIGS. 3 and 4, the activated state (on state) and the deactivated state (off state) of the electro-permanent magnet 1000a including the structure, which includes two first structures 101 and two second structures 102 according to the first exemplary embodiment of the present disclosure, are described, but no such limitation is intended.

In another exemplary embodiment, the device 1400 of the electro-permanent magnet 1000a can change the magnetization of the first magnet 1200 of at least one first structure 101. That is, the strength of the attractive force can be adjusted by changing the magnetization of at least one first magnet 1200 among at least two first structures 101 included in the structure of the electro-permanent magnet 1000a.

Note that Table I below shows an experimental example for the electro-permanent magnet 1000a according to the first exemplary embodiment of the present disclosure and an electro-permanent magnet of the related art.

TABLE 1

| | | |
|---|---|---|
| | | Electro-permanent |
| | Electro-permanent | magnet of the |
| Classification | magnet 1000a | related art |

| | | | | |
|---|---|---|---|---|
| Operating | 24.26 | V | 57.91 | V |
| switching voltage | | | | |

When Switching Voltage = 29.6 V

| | | | |
|---|---|---|---|
| Switching time | 3.11 | ms | N/A |
| Switching energy | 2.06 | J | N/A |

When Switching Voltage = 59.2 V

| | | | | |
|---|---|---|---|---|
| Switching time | 0.96 | ms | 6.31 | ms |
| Switching energy | 1.08 | J | 5.00 | J |

Table 1 shows an experimental example in a situation where the electro-permanent magnet 1000a according to the first exemplary embodiment of the present disclosure and the electro-permanent magnet of the related art have the same weight of 160 g and the same attractive force (adhesive force).

Referring to FIGS. 1 and 2, the device 1400 of the electro-permanent magnet 1000a according to the first exemplary embodiment of the present disclosure is provided in a form of at least partially surrounding the first magnet 1200 and, therefore, can switch the activated state (on state) in which an attractive force is present and the deactivated state (off state) with a significantly lower operating switching voltage compared to the electro-permanent magnet of the related art in which a coil is provided in a form of surrounding both the first magnet 1200 and the second magnet 1300. This may be an effect resulting from the operating voltage according to the difference in the length (magnetic resistance) of the coil surrounding the magnet whose magnetization is intended to be changed (the first magnet 1200 in the present disclosure).

Note that in the case of the operating voltage (59.2 V) of the electro-permanent magnet of the related art, the electro-permanent magnet 1000a according to the first exemplary embodiment of the present disclosure can provide the effect of significantly reducing the switching time between the activated state (on state) and the deactivated state (off state), as well as the effect of reducing the energy required for switching.

Accordingly, the electro-permanent magnet 1000a according to the first exemplary embodiment of the present disclosure can be attached to the feet of a robot or the like and can swiftly move in a ferromagnetic environment in the form of a high-inclination wall and/or vertical wall and/or ceiling according to switching between activation and deactivation. However, this is an example and no such limitation is intended. For example, the electro-permanent magnet can be applied to cases where adhesive force to various ferromagnetic environments is required.

In another exemplary embodiment, the electro-permanent magnet 1000a can be applied to a fixture device to prevent the risk of a user falling when working in a ferromagnetic environment such as a bridge or ship, a transport device that can move a steel structure (steel plate, etc.), and the like.

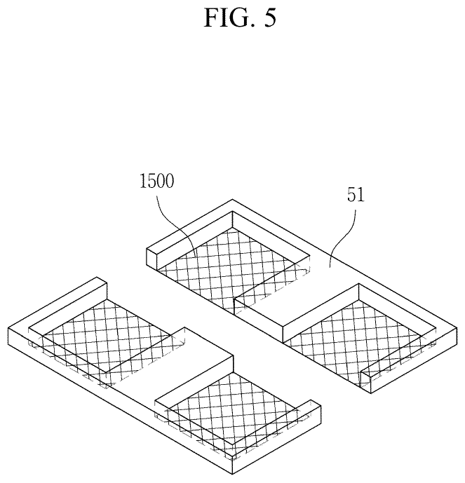

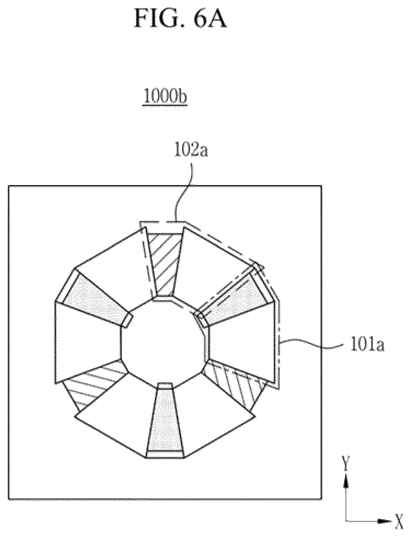

FIG. 5 is a conceptual diagram for illustrating an MRE pad according to an exemplary embodiment.

The electro-permanent magnet 1000a according to an exemplary embodiment of the present disclosure may include a magnetorheological elastomer (hereinafter, referred to as MRE) pad 1500 and a rubber member 51. Here, the rubber member 51 may have frictional force and be configured to be connected to the MRE pad 1500. That is, the rubber member 51 can be connected to the MRE pad 1500 to support the MRE pad 1500 so as to maintain its shape, and can maximize frictional force with a floor surface. Additionally, the rubber member 51 can serve to protect the first magnet 1200 and the second magnet 1300 from the environment of the floor surface. The rubber member 51 may be composed of urethane rubber. However, this is only an example, and the rubber member may be composed of a material capable of maximizing frictional force and/or reducing noise, or protecting the first magnet 1200 and the second magnet 1300.

For example, the electro-permanent magnet 1000a may include the MRE pad 1500. Accordingly, the MRE pad 1500 may be provided corresponding to a size of the core 1100 of the electro-permanent magnet 1000a, which comes into contact with the ferromagnetic environment. Note that the MRE pad 1500 may be adhesively connected to the core 1100 of the electro-permanent magnet 1000a through an adhesive. However, this is only an example, and the MRE pad may be connected to the core 1100 through various ways.

The MRE pad 1500 may be composed of an elastomer (rubber-like material) filled with magnetic particles including iron, cobalt, nickel, and/or the like. When a magnetic field is applied to the MRE pad 1500, the magnetic particles are aligned and form chains, making it rigid. In addition, since the MRE pad 1500 is an elastic body, the MRE pad can improve vertical and/or horizontal adhesive force (attractive force and/or frictional force) in response to gaps that occur when coming into contact with a ferromagnetic environment with rough contact surfaces and/or fine irregularities and/or bends.

The MRE pad 1500 is provided in an area corresponding to the core 1100 of the structure of the electro-permanent magnet 1000a and connected by the rubber member 51, and can protect the first magnet 1200, the second magnet 1300, and the device 1400 from the external environment. However, FIG. 5 is an example, and no such limitation is intended.

The electro-permanent magnet 1000a according to an exemplary embodiment of the present disclosure includes the MRE pad 1500 and the rubber member 51, making it possible to increase the horizontal adhesive force of the electro-permanent magnet 1000a. Since the MRE pad 1500 contains ferromagnetic powder, the MRE pad has a higher magnetic permeability than those of general elastic materials (for example, rubber), making it possible to reduce the loss of adhesive force (attractive force) in the vertical direction (the direction viewed in a plan view) for the ferromagnetic environment and increase the adhesive force in the horizontal direction (the x-axis and/or y-axis direction in a plan view).

Table 2 below shows an experimental example for the electro-permanent magnet 1000a according to an exemplary embodiment of the present disclosure. Here, the adhesive force in the horizontal direction may refer to the adhesive force in the XY plane direction in the coordinate system shown in FIG. 2, and the adhesive force in the vertical direction may refer to the adhesive force (normal force) in the normal direction of the plane in the activated state (on state) of the electro-permanent magnet 1000a.

TABLE 2

| | MRE pad | MRE pad not | Increase-decrease |
|---|---|---|---|
| Classification | included | included | rate |
| Adhesive force in | 697.1N | 535.4N | 23% decrease |
| vertical direction | | | |
| Adhesive force in | 129.3N | 444.6N | 244% increase |
| horizontal direction | | | |

Table 2 shows an experimental example when the electro-permanent magnet 1000a according to an exemplary embodiment of the present disclosure includes the MRE pad 1500 with a thickness of 0.3 mm.

That is, the electro-permanent magnet 1000a according to an exemplary embodiment of the present disclosure includes the MRE pad 1500 and the rubber member 51, making it possible to significantly increase the adhesive force in the horizontal direction in an inclined ferromagnetic environment of 0 to 90 degrees.

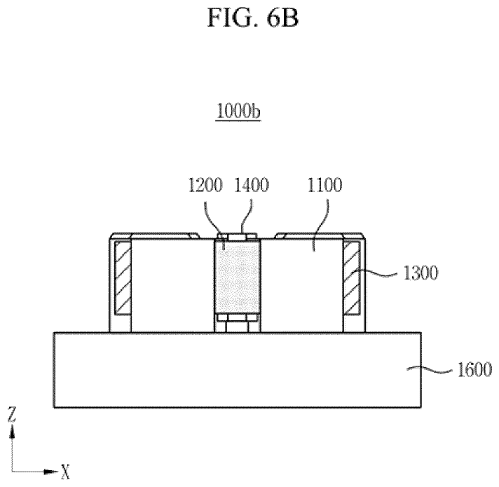

FIGS. 6A and 6B are conceptual diagrams for illustrating an electro-permanent magnet according to an exemplary embodiment.

Referring to FIGS. 6A and 6B, an electro-permanent magnet 1000b according to a second exemplary embodiment of the present disclosure may include a structure including a first structure 101a and a second structure 102a. More specifically, the electro-permanent magnet 1000b may be formed as a hexagonal structure and may include at least three first structures 101a and at least three second structures 102a. FIG. 6B is a conceptual diagram of the electro-permanent magnet 1000b of FIG. 6A viewed in the ty direction.

Here, the first structure 101a may include a core 1100 and a first magnet 1200, and the second structure 102a may include a core 1100 and a second magnet 1300. Accordingly, the electro-permanent magnet 1000b may include a structure in which the first structure 101a and the second structure 102a are alternately connected.

The first structures 101a and the second structures 102a may be alternately connected so that the first magnet 1200 of the first structure 101a and the second magnet 1300 of the second structure 102a included in the structure of the electro-permanent magnet 1000b according to the second exemplary embodiment of the present disclosure are not in contact with each other. That is, the first magnet 1200 of the first structure 101a is connected to the core 1100 of the second structure 102a, and the core 1100 of the first structure 101a is connected to the second magnet 1300 of the second structure 102a, so that the first structures 101a and the second structures 102a may be alternately connected.

As shown in FIG. 6A, when the electro-permanent magnet 1000b includes the hexagonal structure, a first direction formed by a central magnetic field of the first structure 101a and a second direction formed by a central magnetic field of the second structure 102a adjacent to the first structure 101a may be formed to have an angle of 120 degrees with respect to each other. That is, the direction of the central magnetic field of the first structure 101a is formed to have an angle of 120 degrees (or 60 degrees) with the direction of the central magnetic field of each of the two second structures 102a adjacent to the first structure 101a on both sides, so that the structure of the electro-permanent magnet 1000b can be formed as a hexagonal structure.

The shapes of the first magnet 1200 and the second magnet 1300 may be varied to connect the respective cores 1100. For example, an angle between surfaces of the first magnet 1200 and the second magnet 1300 in contact with the core 1100 may be set corresponding to the shape of the structure of the electro-permanent magnet 1000b. As shown by way of example, the shapes of the core 1100, the first magnet 1200, and the second magnet 1300 may be a structure of a square pillar formed in the shape of a trapezoid when viewed in a plan view. However, this is an example, and no such limitation is intended. That is, the core 1100, the first magnet 1200, and the second magnet 1300 may be provided in such a shape and/or structure that an angle between the first direction formed by the central magnetic field of the first structure 101a and the second direction formed by the central magnetic field of the second structure 102a adjacent to the first structure 101a can be 120 degrees (or 60 degrees).

Referring to FIG. 6B, the first magnet 1200 and/or the second magnet 1300 of the electro-permanent magnet 1000b may be provided between the cores 1100, but may be arranged at a distance from a lower surface of the core 1100 in the y-axis direction so as not to come into contact with the ferromagnetic material 1600. That is, the first magnet 1200 and/or the second magnet 1300 may be provided to be smaller in size than the core 1100 so as not to come into contact with the ferromagnetic environment between the cores 1100. Note that since the first magnet 1200 can be at least partially surrounded by the device 1400 in the form of a coil, the first magnet can be provided to be smaller than the core 1100, including the size of the device 1400. However, this is an example, and no such limitation is intended.

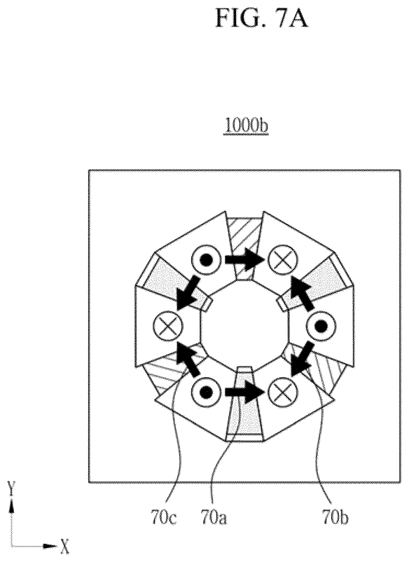

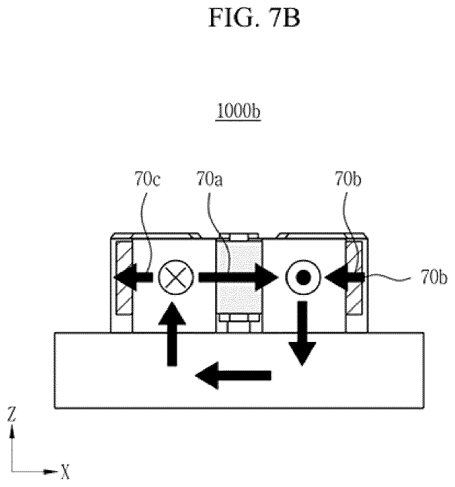

FIGS. 7A and 7B are conceptual diagrams for illustrating a magnetic field direction of the electro-permanent magnet according to the exemplary embodiment.

Referring to FIGS. 7A and 7B, the second magnet 1300 of the electro-permanent magnet 1000b may include a magnet having higher coercivity than that of the first magnet 1200 whose magnetization direction is difficult to change. In this case, the device 1400 can change a magnetic field direction 70a of the first magnet 1200 through a current pulse so that the magnetic field of the first magnet 1200 is directed toward the core 1100 adjacent to the first magnet 1200, toward which the magnetic field direction of the second magnet 1300 is directed. FIG. 7B is a view of the electro-permanent magnet 1000b of FIG. 7A viewed in the +y direction.

Referring to FIG. 7A, the device 1400 can cause the magnetic field directions of the first magnet 1200 and the second magnet 1300 to be directed toward the same core 1100 through a current pulse. Accordingly, magnetic fluxes from the first magnet 1200 and the second magnet 1300 are concentrated in the core 110, and the concentrated magnetic fluxes can form a magnetic current directed toward the ferromagnetic material 1600 in contact with the core 1100. That is, in FIG. 7A, which shows the electro-permanent magnet 1000b in a plan view, a magnetic field 70a formed by the first magnet 1200 and magnetic fields 70b and 70c formed by the second magnets 1300 may be formed in a direction entering the core 1100, while in the adjacent core 1100, the magnetic field may be formed in an exiting direction.

Referring to FIG. 7B, the electro-permanent magnet 1000b according to an exemplary embodiment of the present disclosure can form a first external magnetic field when the device 1400 changes the magnetization direction formed by the first magnet 1200 toward the adjacent core 1100 in the magnetization direction formed by the second magnet 1300. Here, the first external magnetic field may be formed along the core 1100 and the ferromagnetic material 1600. Accordingly, the electro-permanent magnet 1000b can obtain an attractive force (adhesive force) to the ferromagnetic material 1600.

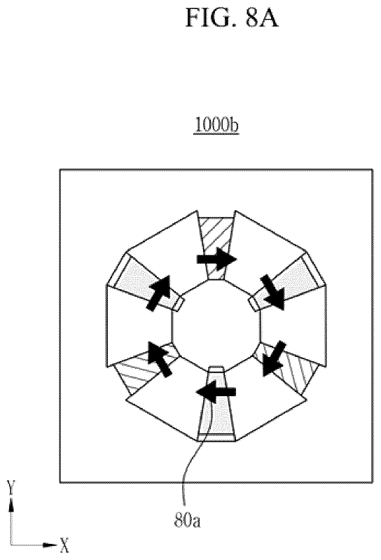

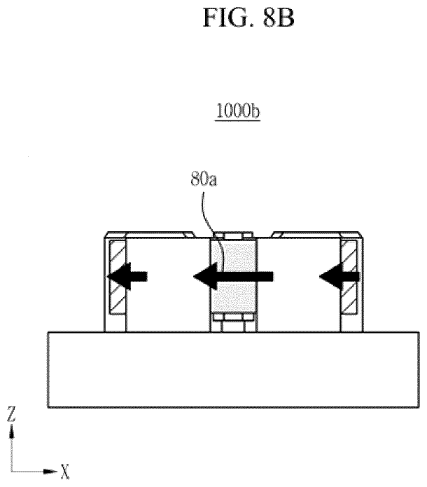

FIGS. 8A and 8B are conceptual diagrams for illustrating a magnetic field direction of the electro-permanent magnet according to the exemplary embodiment.

Referring to FIGS. 8A and 8B, the device 1400 can change the direction of the magnetic field of the first magnet 1200 through a current pulse so that it is directed toward the core 1100 opposite to the core 110 in the direction of the magnetic field of the second magnet 1300. That is, the device 1400 can change the magnetic field direction of the first magnet 1200 so as to form a magnetic current according to the magnetic field direction of the second magnet 1300. FIG. 8B is a conceptual diagram of the electro-permanent magnet 1000b of FIG. 8A viewed in the +y direction.

Accordingly, in the electro-permanent magnet 1000b according to an exemplary embodiment of the present disclosure, an external magnetic field may not be formed when the device 1400 changes the magnetic field direction of the first magnet 1200 and thus an internal magnetic current is formed in the core 1100, the first magnet 1200, and the second magnet 1300. That is, the electro-permanent magnet 1000b can maintain a deactivated state (off state) in which it generates a second external magnetic field smaller than the first external magnetic field described in FIG. 7, or generates no external magnetic field.

That is, when the electro-permanent magnet 1000b according to an exemplary embodiment of the present disclosure is in the deactivated state (off state), a magnetic field 80a generated by the first magnet 1200 and the second magnet 1300 forms a magnetic current inside the structure of the electro-permanent magnet 1000b and may have no attractive force or have an attractive force weaker than that in the activated state (on state) due to no external magnetic field being generated or the second external magnetic field being smaller than the first external magnetic field.

Note that in FIGS. 7 and 8, the activated state (on state) and the deactivated state (off state) of the electro-permanent magnet 1000b including the structure, which includes three first structures 101a and three second structures 102a according to the second exemplary embodiment of the present disclosure, are described, but no such limitation is intended.

In another exemplary embodiment, the device 1400 of the electro-permanent magnet 1000b can change the magnetization of the first magnet 1200 of at least one first structure 101a. That is, the strength of the attractive force can be adjusted by changing the magnetization of at least one first magnet 1200 among at least three first structures 101a included in the structure of the electro-permanent magnet 1000b.

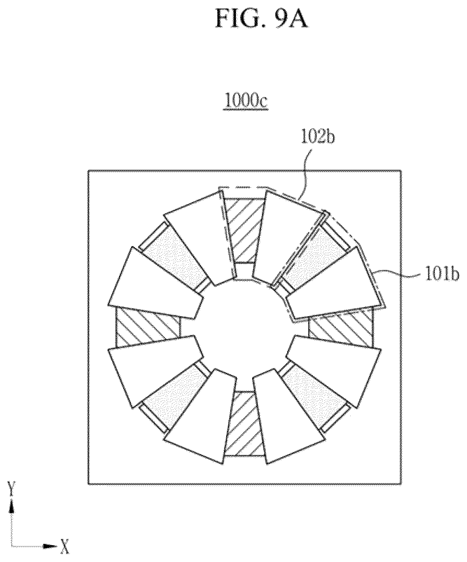

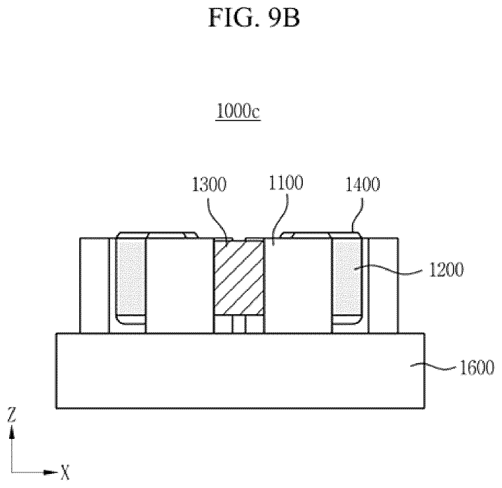

FIGS. 9A and 9B are conceptual diagrams for illustrating an electro-permanent magnet according to an exemplary embodiment.

Referring to FIGS. 9A and 9B, an electro-permanent magnet 1000c according to a third exemplary embodiment of the present disclosure may include a structure including a first structure 101b and a second structure 102b. More specifically, the electro-permanent magnet 1000c may be formed as an octagonal structure and may include at least four first structures 101b and at least four second structures 102b. FIG. 9B is a conceptual diagram of the electro-permanent magnet 1000c of FIG. 9A viewed in the +y direction.

Here, the first structure 101b may include a core 1100 and a first magnet 1200, and the second structure 102b may include a core 1100 and a second magnet 1300. Accordingly, the electro-permanent magnet 1000c may include a structure in which the first structure 101b and the second structure 102b are alternately connected.

The first structures 101b and the second structures 102b may be alternately connected so that the first magnet 1200 of the first structure 101b and the second magnet 1300 of the second structure 102b included in the structure of the electro-permanent magnet 1000e according to the third exemplary embodiment of the present disclosure are not in contact with each other. That is, the first magnet 1200 of the first structure 101b is connected to the core 1100 of the second structure 102b, and the core 1100 of the first structure 101b is connected to the second magnet 1300 of the second structure 102b, so that the first structures 101b and the second structures 102b may be alternately connected.

As shown in FIGS. 9A and 9B, when the electro-permanent magnet 1000c includes the octagonal structure, a first direction formed by a central magnetic field of the first structure 101b and a second direction formed by a central magnetic field of the second structure 102b adjacent to the first structure 101b may be formed to have an angle of 135 degrees (or 45 degrees) with respect to each other. That is, the direction of the central magnetic field of the first structure 101b is formed to have an angle of 135 degrees (or 45 degrees) with the direction of the central magnetic field of each of the two second structures 102b adjacent to the first structure 101b on both sides, so that the structure of the electro-permanent magnet 1000c can be formed as an octagonal structure.

Referring to FIG. 9A, the shapes of the first magnet 1200 and the second magnet 1300 may be varied to connect the respective cores 1100. For example, an angle between surfaces of the first magnet 1200 and the second magnet 1300 in contact with the core 1100 may be set corresponding to the shape of the structure of the electro-permanent magnet 1000c. As shown for example, the shapes of the core 1100, the first magnet 1200, and the second magnet 1300 may be a structure of a square pillar formed in the shape of a trapezoid when viewed in a plan view. However, this is an example, and no such limitation is intended. That is, the core 1100, the first magnet 1200, and the second magnet 1300 may be provided in such a shape and/or structure that an angle between the first direction formed by the central magnetic field of the first structure 101b and the second direction formed by the central magnetic field of the second structure 102b adjacent to the first structure 101b can be 135 degrees (45 degrees).

Referring to FIG. 9B, the first magnet 1200 and/or the second magnet 1300 of the electro-permanent magnet 1000c may be provided between the cores 1100, but may be arranged at a distance from a lower surface of the core 1100 in the y-axis direction so as not to come into contact with the ferromagnetic material 1600. That is, the first magnet 1200 and/or the second magnet 1300 may be provided to be smaller in size than the core 1100 so as not to come into contact with the ferromagnetic environment between the cores 1100. Note that since the first magnet 1200 can be at least partially surrounded by the device 1400 in the form of a coil, the first magnet can be provided to be smaller than the core 1100, including the size of the device 1400. However, this is an example, and no such limitation is intended.

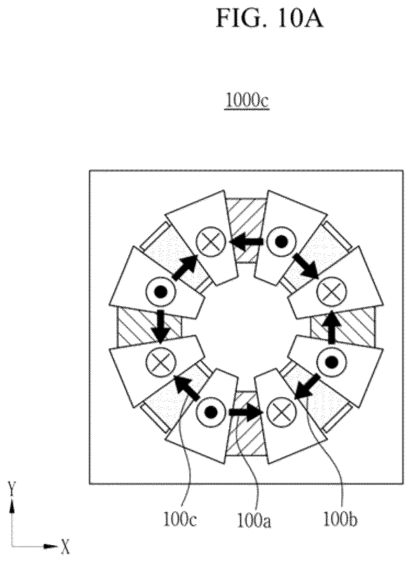

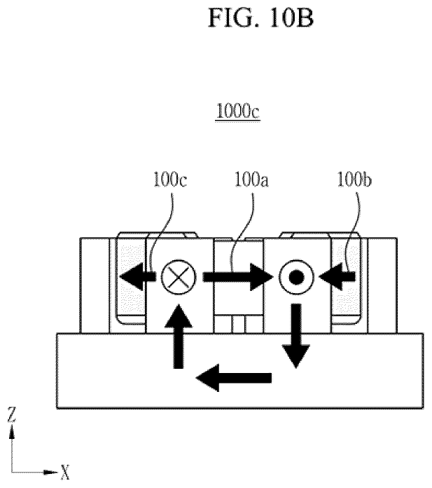

FIGS. 10A and 10B are conceptual diagrams for illustrating a magnetic field direction of the electro-permanent magnet according to the exemplary embodiment.

Referring to FIGS. 10A and 10B, the second magnet 1300 of the electro-permanent magnet 1000c may include a magnet having higher coercivity than that of the first magnet 1200 whose magnetization direction is difficult to change. In this case, the device 1400 can change magnetic field directions 100b and 100c of the first magnets 1200 through a current pulse so that the magnetic field of the first magnet 1200 is directed toward the core 1100 adjacent to the first magnet 1200, toward which a magnetic field direction 100a of the second magnet 1300 is directed. FIG. 10B is a conceptual diagram of the electro-permanent magnet 1000c of FIG. 10A viewed in the +y direction.

Referring to FIG. 10A, the device 1400 can cause the magnetic field directions of the first magnet 1200 and the second magnet 1300 to be directed toward the same core 1100 through a current pulse. Accordingly, magnetic fluxes from the first magnet 1200 and the second magnet 1300 are concentrated in the core 110, and the concentrated magnetic fluxes can form a magnetic current directed toward the ferromagnetic material 1600 in contact with the core 1100. That is, as shown in the drawing, which shows the electro-permanent magnet 1000c in a plan view, the magnetic fields 100b and 100c formed by the first magnets 1200 and the magnetic field 100a formed by the second magnet 1300 may be formed in a direction entering the core 1100, while in the adjacent core 1100, the magnetic field may be formed in an exiting direction.

Referring to FIG. 10B, the electro-permanent magnet 1000c according to an exemplary embodiment of the present disclosure can form a first external magnetic field when the device 1400 changes the magnetization direction formed by the first magnet 1200 toward the adjacent core 1100 in the magnetization direction formed by the second magnet 1300. Here, the first external magnetic field may be formed along the core 1100 and the ferromagnetic material 1600. Accordingly, the electro-permanent magnet 1000a can obtain an attractive force (adhesive force) to the ferromagnetic material 1600. This is referred to as an activated state (on state) of the electro-permanent magnet 1000c.

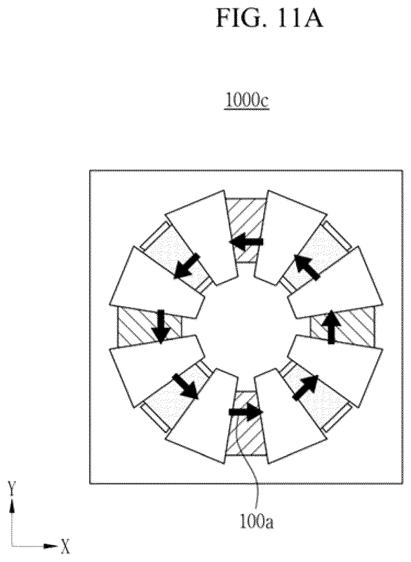

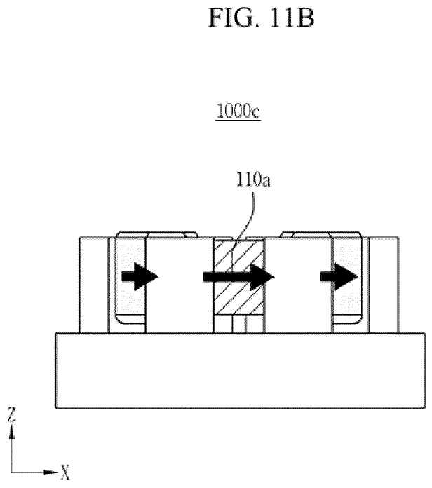

FIGS. 11A and 11B are conceptual diagrams for illustrating a magnetic field direction of the electro-permanent magnet according to the exemplary embodiment.

Referring to FIGS. 11A and 11B, the device 1400 can change the direction of the magnetic field of the first magnet 1200 through a current pulse so that it is directed toward the core 1100 opposite to the core 110 in the direction of the magnetic field of the second magnet 1300. That is, the device 1400 can change the magnetic field direction of the first magnet 1200 so as to form a magnetic current according to the magnetic field direction of the second magnet 1300. FIG. 11B is a conceptual diagram of the electro-permanent magnet 1000c of FIG. 11A viewed in the +y direction.

Accordingly, in the electro-permanent magnet 1000c according to an exemplary embodiment of the present disclosure, an external magnetic field may not be formed when the device 1400 changes the magnetic field direction of the first magnet 1200 and thus an internal magnetic current is formed in the core 1100, the first magnet 1200, and the second magnet 1300. That is, the electro-permanent magnet 1000a can maintain a deactivated state (off state) in which it generates a second external magnetic field smaller than the first external magnetic field described in FIG. 10, or generates no external magnetic field.

That is, when the electro-permanent magnet 1000c according to an exemplary embodiment of the present disclosure is in the deactivated state (off state), a magnetic field 110a generated by the first magnet 1200 and the second magnet 1300 forms a magnetic current inside the structure of the electro-permanent magnet 1000c and may have no attractive force or have an attractive force weaker than that in the on state due to no external magnetic field being generated or the second external magnetic field being smaller than the first external magnetic field.

Note that in FIGS. 10 and 11, the activated state (on state) and the deactivated state (off state) of the electro-permanent magnet 1000c including the structure, which includes four first structures 101b and four second structures 102b according to the third exemplary embodiment of the present disclosure, are described, but no such limitation is intended.

In another exemplary embodiment, the device 1400 of the electro-permanent magnet 1000c can change the magnetization of the first magnet 1200 of at least one first structure 101b. That is, the strength of the attractive force can be adjusted by changing the magnetization of at least one first magnet 1200 among at least four first structures 101b included in the structure of the electro-permanent magnet 1000c.

The electro-permanent magnet 1000 according to an exemplary embodiment of the present disclosure described above includes the structure, which includes the first structure 101 and the second structure 102, and can switch the activated state (on state) and the deactivated state (off state) by changing the magnetization direction of the first magnet 1200 of the first structure 101 through the device 1400. In the electro-permanent magnet 1000, the strength of the attractive force (adhesive force) to the ferromagnetic environment can be controlled by differently controlling each device 1400.

Note that the electro-permanent magnet may have a different shape of the first structure 101 and/or the second structure 120 depending on the number of the first structures 101 and/or the second structures 102.

That is, it can be understood that the electro-permanent magnet 1000 may include a structure including a plurality of first structures 101 and a plurality of second structures 102, and may be applied to a wider variety of structures without being limited to the exemplary embodiments described above. For example, the above-described electro-permanent magnets (1000a. 1000b, 1000c) have been described as including structures in the shapes of square, hexagon, and octagon, respectively, but are not limited thereto, and electro-permanent magnets 1000 of various shapes may be implemented depending on the connection of the first structures 101 and the second structures 102.

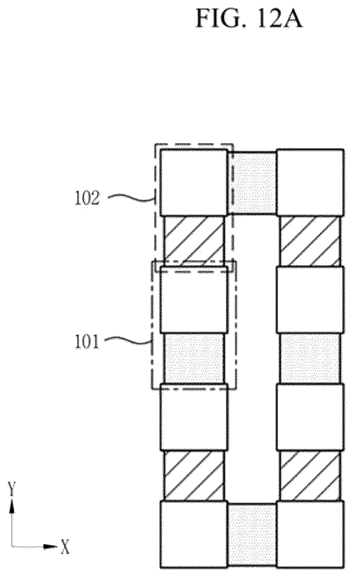

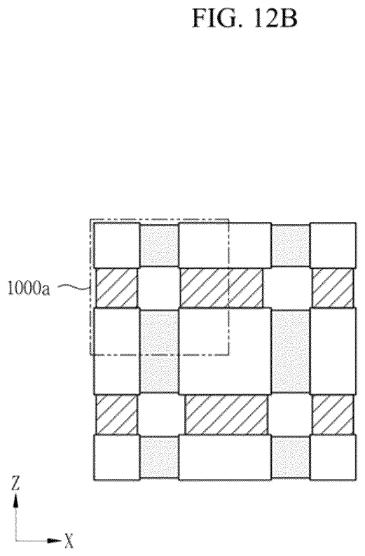

FIGS. 12A and 12B are conceptual diagrams for illustrating an electro-permanent magnet according to an exemplary embodiment.

Referring to FIGS. 12A and 12B, the electro-permanent magnet 1000 according to an exemplary embodiment of the present disclosure may include a structure including a first structure 101 and a second structure 102. More specifically, the structure including the first structure 101 and the second structure 102 is not limited to a regular polygonal shape and may be applied as a rectangular structure.

In the electro-permanent magnet 1000 according to an exemplary embodiment of the present disclosure, on two sides parallel to the y-axis, the first structures 101 and the second structures 102 may be connected alternately in a straight line shape, and on two sides parallel to the x-axis, the first structures 101 and/or the second structures 102 may be connected such that the first magnet 1200 and second magnet 1300 can be alternately connected with respect to the core 1100. In this case, the angle between the first direction of the central magnetic field of the first structure 101 and the second direction of the central magnetic field of the second structure 102 can be set to 0 degree or 90 degrees.

Referring to FIG. 12A, the device 1400 surrounding at least a part of the first magnet 1200 of the electro-permanent magnet 1000 can change the magnetization direction of the first magnet 1200 using a current pulse. More specifically, the magnetic field of the first magnet 1200 of the first structure 101 of the electro-permanent magnet 1000 can be changed by the device 1400 such that it is directed toward the core 1100 adjacent to the second magnet 1300 in the magnetization direction. Accordingly, the magnetization toward the core 1100 can form a magnetic current within the ferromagnetic environment in the entering direction in a plan view. The magnetic current within the ferromagnetic environment can connect to a magnetic current in an exiting direction in a plan view through the core 1100 adjacent to the direction opposite to the magnetization direction of the second magnet 1300.

In this case, the electro-permanent magnet 1000 can be in an activated state (on state) in which it can provide an attractive force to a ferromagnetic environment by forming a first external magnetic field. In the opposite case, the electro-permanent magnet 1000 can be in an off state in which the magnetization of the first magnet 1200 of the first structure 101 is changed by the device 1400, a magnetic current is formed inside the structure along the magnetization direction of the second magnet 1300, and a second external magnetic field smaller than the first external magnetic field in the above-described activated state (on state) is generated or no external magnetic field is generated.

Referring to FIG. 12B, an electro-permanent magnet 1000 formed by arranging four electro-permanent magnets 1000a described in FIGS. 2 to 5 is shown. This is only an example, and in another exemplary embodiment, the electro-permanent magnet 1000 may be formed as a structure including nine electro-permanent magnets 1000a. Accordingly, the same contents described in FIGS. 2 to 5 can be applied.

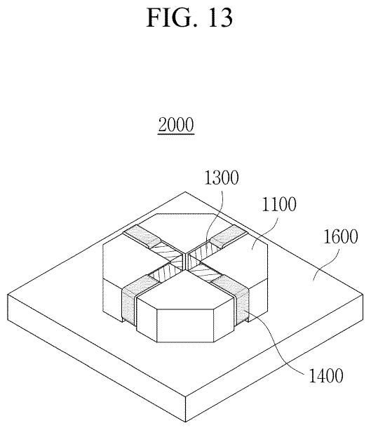

FIG. 13 is a conceptual diagram for illustrating an electro-permanent magnet according to an exemplary embodiment.

Referring to FIG. 13, an electro-permanent magnet 2000 according to an exemplary embodiment may include a structure including a core 1100, a first magnet 1200, a second magnet 1300, and a device 1400. The electro-permanent magnet 2000 may include a structure formed so that the disadvantages of electro-permanent magnets of the related art can be overcome.

The electro-permanent magnet 2000 according to an exemplary embodiment of the present disclosure may include four cores 1100. Here, the shape of the core 1100 may be provided as a pentagonal pillar shape as shown, but this is an example, and in another exemplary embodiment, the core 1100 may be provided as a pillar with fan-shaped upper and lower surfaces.

Each core 1100 can be arranged at a predetermined distance from the adjacent core 1100. That is, each core 1100 may be arranged at a predetermined distance apart such that spaces between the respective cores 1100 may form a cross shape.

The first magnet 1200 and the second magnet 1300 may be arranged within the predetermined distance between the cores 1100, connecting the cores 1100. That is, the first magnet 1200 and the second magnet 1300 are arranged in parallel between the cores 1100 and can each connect the cores 1100. Accordingly, the first magnet 1200 and the second magnet 1300 are arranged in parallel between the respective four cores 1100, so that the electro-permanent magnet 2000 can include the four first magnets 1200 and the four second magnets 1300.

Note that, in FIG. 13, the first magnet 1200 is not shown because it is at least partially surrounded by the device 1400, but the first magnet 1200 may be included within the device 1400.

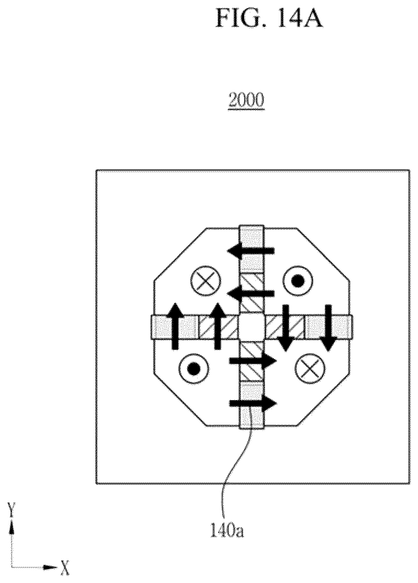

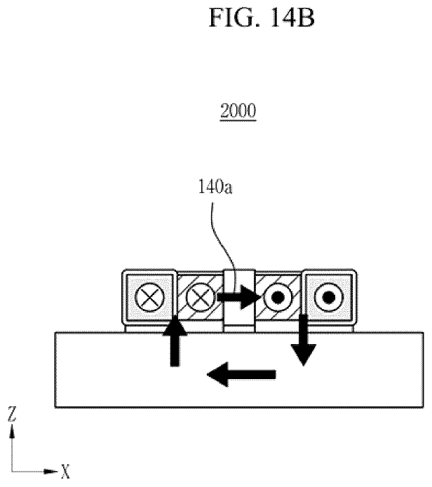

FIGS. 14A and 14B are conceptual diagrams for illustrating a magnetic field direction of the electro-permanent magnet according to the exemplary embodiment.

Referring to FIGS. 14A and 14B, the second magnet 1300 of the electro-permanent magnet 2000 may include a magnet having higher coercivity than that of the first magnet 1300. That is, the first magnet 1200 has lower coercivity than that of the second magnet 1300, so that the magnetization direction thereof can be easily changed. In this case, the device 1400 can change a magnetic field direction 140a of the first magnet 1200 through a current pulse so that the magnetic field of the first magnet 1200 is directed toward the core 1100, toward which the magnetic field direction of the second magnet 1300 arranged parallel to the first magnet 1200 is directed. FIG. 14B is a conceptual diagram of the electro-permanent magnet 2000 of FIG. 14A viewed in the +y direction.

Referring to FIG. 14A, the device 1400 can cause the magnetic field directions of the first magnet 1200 and the second magnet 1300 to be directed toward the same core 1100 through a current pulse. Accordingly, magnetic fluxes from the first magnet 1200 and the second magnet 1300 are concentrated in the core 110, and the concentrated magnetic fluxes can form a magnetic current directed toward the ferromagnetic material 1600 in contact with the core 1100. That is, as shown in the drawing, which shows the electro-permanent magnet 2000 in a plan view, the magnetic field 140a formed by the first magnet 1200 and the magnetic field formed by the second magnet 1300 may be formed in a direction entering the adjacent core 1100, while in the adjacent core 1100 in the opposite direction, the magnetic field may be formed in an exiting direction.

Referring to FIG. 14B, the electro-permanent magnet 2000 according to an exemplary embodiment of the present disclosure can form a first external magnetic field when the device 1400 changes the magnetization direction formed by the first magnet 1200 arranged in parallel toward the core 1100 in the magnetization direction formed by the second magnet 1300. Here, the first external magnetic field may be formed along the core 1100 and the ferromagnetic material 1600. Accordingly, the electro-permanent magnet 2000 can obtain an attractive force (adhesive force) to the ferromagnetic material 1600.

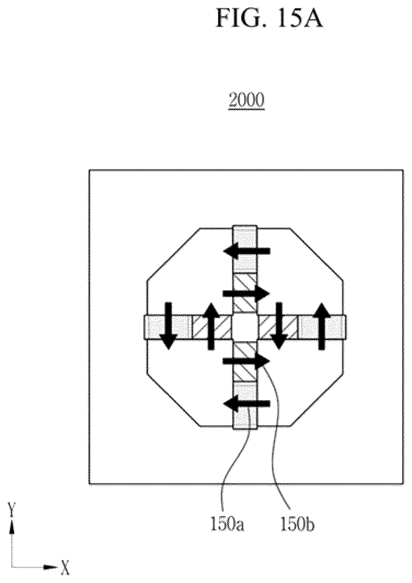

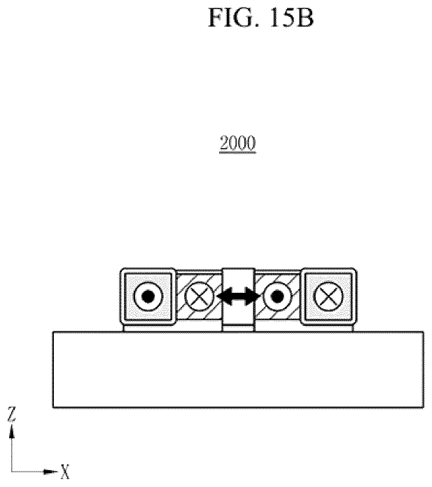

FIGS. 15A and 15B are conceptual diagrams for illustrating a magnetic field direction of the electro-permanent magnet according to the exemplary embodiment.

Referring to FIGS. 15A and 15B, the device 1400 can change the direction of the magnetic field of the first magnet 1200 through a current pulse so that it is directed toward the core 1100 opposite to the core 110 in the direction of the magnetic field 150b of the second magnet 1300. That is, the device 1400 can change the magnetization direction to the opposite direction 150a to the magnetization direction of the second magnet 1300 arranged parallel to the first magnet 1200. FIG. 15B is a conceptual diagram of the electro-permanent magnet 2000 of FIG. 15A viewed in the +y direction.

Accordingly, in the electro-permanent magnet 2000 according to an exemplary embodiment of the present disclosure, an external magnetic field may not be formed when the device 1400 changes the magnetic field direction of the first magnet 1200 and thus an internal magnetic current is formed in the core 1100, the first magnet 1200, and the second magnet 1300. That is, the electro-permanent magnet 2000 can maintain a deactivated state (off state) in which it generates a second external magnetic field smaller than the first external magnetic field described in FIG. 14, or generates no external magnetic field.

That is, when the electro-permanent magnet 2000 according to an exemplary embodiment of the present disclosure is in an off state, the magnetic field generated by the first magnet 1200 and the second magnet 1300 forms a magnetic current inside the structure of the electro-permanent magnet 2000 and may have no attractive force or have an attractive force weaker than that in the activated state (on state) due to no external magnetic field being generated or the second external magnetic field being smaller than the first external magnetic field.

An electronic device according to an exemplary embodiment of the present disclosure may include the above-described electro-permanent magnet (1000, 2000) and a controller.

The controller may include a processor and a memory.

The processor can output a signal to control the device 1400 to change the magnetization direction of at least one first magnet 1200 of the electro-permanent magnets (1000, 2000).

The processor can output a signal to control the device 1400 in a situation (adhesion requirement situation) where an adhesive force (attractive force) of the electro-permanent magnet (1000, 2000) to a ferromagnetic environment including the ferromagnetic material 1600 is required, thereby controlling the device 1400 to generate a current pulse. Here, the adhesion requirement situation may refer to, For example, a situation where when the robot needs to move in an inclined ferromagnetic environment, a horizontal adhesive force to a ferromagnetic environment is required, but this is an example and no such limitation is intended.

The processor can output a signal for controlling the device 1400 to cause the electro-permanent magnet (1000, 2000) to generate a first external magnetic field in the situation where an adhesive force is required. When the situation (adhesion request situation) where an adhesive force is required is terminated, the processor can output a signal to control the device 1400 to generate a second external magnetic field smaller than the first external magnetic field or not to generate an external magnetic field.

The processor can generate a signal to control the device 1400 to change the magnetic field direction of at least one first magnet 1200 included in the electro-permanent magnet (1000, 2000). That is, the processor can output a signal to control the device 1400 to change the magnetic field direction of each of at least one first magnet 1200 and to differently change the magnetic field directions of the different first magnets 1200.

The processor according to an exemplary embodiment of the present disclosure can output a signal for controlling the device 1400 at least partially surrounded around the first magnet 1200 to change the intensity of a first external magnetic field so as to control the electronic magnet (1000, 2000) in which the first magnet 1200 and the second magnet 1300 are provided in plural in equal quantities. That is, the processor can output a signal for controlling each device 1400 to change the magnetization direction of at least one first magnet 1200 among the plurality of first magnets 1200.

The processor may include a digital signal processor (DSP) and/or a micro control unit (MCU).

The memory may store a program that performs the operations described above and operations described below, and the processor can execute the stored program. When there are multiple memories and processors, they can be integrated into a single chip or provided in physically separate locations. The memory may include a volatile memory such as a static random access memory (S-RAM) and a dynamic random access memory (DRAM) for temporarily storing data. Additionally, the memory may include a non-volatile memory such as read only memory (ROM), an erasable programmable read only memory (EPROM), and an electrically erasable programmable read only memory (EEPROM) for long-term storage of control programs and control data. The processor may include various logic circuits and arithmetic circuits, process data according to a program provided from the memory, and generate a control signal according to a processing result.

A method for controlling the electronic device can be performed by the electronic device and electro-permanent magnet (1000, 2000) described above. Therefore, even if the description is omitted below, the contents described with respect to the electronic device and the electro-permanent magnet (1000, 2000) can be equally applied to the description of the method for controlling the electronic device.

The electronic device can switch an activated state in which a first external magnetic field is generated and a deactivated state in which a second external magnetic field smaller than the first external magnetic field is generated or an external magnetic field is not generated.

Additionally, the switching may include switching to the activated state in the adhesion requirement situation to a ferromagnetic environment.

Additionally, the switching may include switching to the deactivated state when the adhesion requirement situation to the ferromagnetic environment is terminated.

Note that the disclosed exemplary embodiments can be implemented in the form of a recording medium storing instructions executable by a computer. The instructions may be stored in the form of a program code, which, when executed by the processor, may generate program modules to perform the operations of the disclosed exemplary embodiments. The recording medium can be implemented as a computer-readable recording medium.

The computer-readable recording medium includes all types of recording media that store instructions that can be decoded by a computer. Examples of the computer-readable recording medium include a read only memory (ROM), a random access memory (RAM), a magnetic tape, a magnetic disk, a flash memory, and an optical data storage device.

The disclosed exemplary embodiments have been described with reference to the accompanying drawings. One skilled in the art to which the present invention pertains will appreciate that the present invention can be implemented in forms other than the disclosed exemplary embodiments without changing the technical spirit or essential characteristics of the present invention. The disclosed exemplary embodiments are illustrative and should not be construed as limiting.

[Reference Signs List]

| | |
|---|---|
| 1000, 2000: electro-permanent magnet | |
| 110: first structure | |
| 120: second structure | |
| 1100: core | 1200: first magnet |
| 1300: second magnet | 1400: device |
| 1500: MRE pad | 1600: ferromagnetic material |

What is claimed is:

1. An electro-permanent magnet (EPM) comprising a structure,
wherein the structure comprises:
at least one first magnet;
at least one second magnet;
at least one core associated with formation of a magnetic field within the structure; and
a device configured to change a direction of a magnetic field of the at least one first magnet,
wherein the core is arranged between the first magnet and the second magnet, and
wherein the first magnet and the second magnet are connected via the core.

2. The electro-permanent magnet of claim 1, wherein the structure comprises:
at least one first structure in which the core and the first magnet are connected; and
at least one second structure in which the core and the second magnet are connected, and
wherein the at least one first structure and the at least one second structure are connected alternately with each other.

3. The electro-permanent magnet of claim 2, wherein the structure is formed that the core of the first structure and the second magnet of the second structure are connected, and the core of the second structure and the first magnet of the first structure are connected.

4. The electro-permanent magnet of claim 3, wherein the first magnet and the second magnet are not in contact with each other.

5. The electro-permanent magnet of claim 4, wherein the structure corresponds to a rectangle, and a first direction formed by a central magnetic field of the first structure and a second direction formed by a central magnetic field of the second structure form an angle.

6. The electro-permanent magnet of claim 1, wherein the first magnet and the second magnet comprise materials different from each other.

7. The electro-permanent magnet of claim 6, wherein the first magnet comprises a soft or semi-hard magnetic material, and the second magnet comprises a hard magnetic material.

8. The electro-permanent magnet of claim 6, wherein the first magnet comprises a ferromagnetic material, and
wherein the second magnet comprises a hard magnetic material.

9. The electro-permanent magnet of claim 1, wherein the device is configured to switch an activated state in which a first external magnetic field is generated and a deactivated state in which a second external magnetic field smaller than the first external magnetic field is generated or an external magnetic field is not generated.

10. The electro-permanent magnet of claim 9, wherein the device comprises a wire winding or a solenoid and is at least partially arranged on the first magnet.

11. The electro-permanent magnet of claim 1, further comprising a magnetorheological elastomer (MRE),
wherein the magnetorheological elastomer comprises magnetic particles and an elastomer.

12. An electronic device comprising:
an electro-permanent magnet (EPM) comprising a structure; and
a controller configured to control the electro-permanent magnet,
wherein the structure comprises:
at least one first magnet;
at least one second magnet;
at least one core associated with formation of a magnetic field within the structure; and
a device configured to change a direction of a magnetic field of the at least one first magnet, and
wherein the controller is configured to control the device to switch an activated state in which a first external magnetic field is generated and a deactivated state in which a second external magnetic field smaller than the first external magnetic field is generated or an external magnetic field is not generated.

13. The electronic device of claim 12, wherein the controller is configured to control the device to change a direction of a magnetic field of each of the at least one first magnet.

14. The electronic device of claim 12, wherein the electron permanent magnet comprises
the first magnet and the second magnet provided in plural in equal quantities, and
wherein the controller is configured to control the device to change magnetization of at least one first magnet among the plurality of first magnets so as to change an intensity of the first external magnetic field.

15. A method of operating an electronic device comprising an electro-permanent magnet (EPM), the method comprising:
controlling a device configured to change a direction of a magnetic field of at least one first magnet included in the electro-permanent magnet, thereby switching an activated state in which a first external magnetic field is generated and a deactivated state in which a second external magnetic field smaller than the first external magnetic field is generated or an external magnetic field is not generated.

16. The method of claim 15, wherein the switching comprises:
switching to the activated state when there is an adhesion requirement situation to a ferromagnetic environment, and
switching to the deactivated state when the adhesion requirement situation is terminated.

17. The method of claim 15, wherein the electron permanent magnet comprises:
at least one first magnet;
at least one second magnet;
at least one core associated with formation of a magnetic field within the structure; and
a device configured to change a direction of a magnetic field of the at least one first magnet.
